(19) United States
(12) Patent Application Publication
(10) Pub. No.: US 2010/0107128 A1
(43) Pub. Date: Apr. 29, 2010

(54) DISPLAYING AVAILABLE CONTENT VIA A SCREEN SAVER

(75) Inventor: Vivek Thukral, Palo Alto, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/259,057

(22) Filed: Oct. 27, 2008

(51) Int. Cl. G06F 3/14

(52) U.S. Cl. 715/867

(57) ABSTRACT

In a device, multiple content descriptions are obtained. Each of the content descriptions identifies content that is available to the device, such as video on demand (VOD) programs, previously recorded programs, live programs, applications that can be run, and so forth. A screen saver is generated to concurrently display each of the multiple content descriptions as at least part of a screen saver for the device.

### BACKGROUND

A variety of different content from a variety of different sources is frequently available to television viewers. This content can include live programs, previously recorded programs, video on demand programs, and so forth. A listing of titles of content that is available to users, such as an electronic programming guide, can be presented to users to allow them to view a list of available content. However, it remains difficult for content authors and distributors to bring attention to particular content that is available. This can detract from the user experience as it remains difficult to identify particular programming that users may be interested in viewing.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, multiple content descriptions are obtained. Each of the content descriptions identifies content that is available to a device. A screen saver is generated to concurrently display each of the multiple content descriptions as at least part of a screen saver for the device.

### BRIEF DESCRIPTION OF THE DRAWINGS

The same numbers are used throughout the drawings to reference like features.

FIG. 1 illustrates an example device implementing the displaying available content via a screen saver in accordance with one or more embodiments.

FIGS. 2, 3, and 4 illustrate example screen savers in accordance with one or more embodiments.

FIG. 5 is a flowchart illustrating an example process for displaying available content via a screen saver in accordance with one or more embodiments.

FIG. 6 illustrates an example system in which one or more embodiments of displaying available content via a screen saver can be implemented.

FIG. 7 illustrates various components of an example consumer device that can implement one or more embodiments of displaying available content via a screen saver.

FIG. 8 illustrates an example entertainment and information system in which one or more embodiments of displaying available content via a screen saver can be implemented.

### DETAILED DESCRIPTION

Displaying available content via a screen saver is discussed herein. Various content can be available to a user of a device, such as video on demand (VOD) programs, previously recorded programs, live programs, applications that can be run, and so forth. Information, such as a video preview, image, or text describing content is displayed as part of a screen saver of the device. The user is able to select particular content corresponding to the information being displayed, and have that content downloaded to and/or played back at the device.

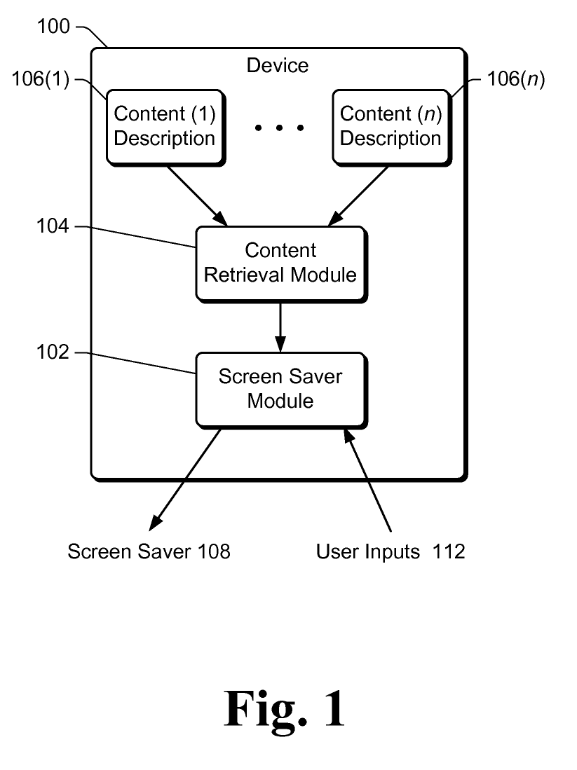

FIG. 1 illustrates an example device 100 implementing the displaying available content via a screen saver in accordance with one or more embodiments. Device 100 can be any of a variety of devices that output video for display. For example, device 100 can be a computer, such as a desktop computer or a server computer, a handheld computer or personal digital assistant (PDA), a mobile station, an entertainment appliance, a set-top box communicatively coupled to a display device, a video playback device (e.g., digital video recorder (DVR), digital versatile disk (DVD) player, etc.), a television, a cell or other wireless phone, a game console, an automotive PC, and so forth. Thus, device 100 can range from full resource devices with substantial memory and processor resources (e.g., personal computers, game consoles, etc.) to low-resource devices with limited memory and/or processing resources (e.g., traditional set-top boxes, hand-held game consoles, DVD players, etc.).

Device 100 includes a screen saver module 102, a content retrieval module 104, and multiple (n) content descriptions 106(1), . . . , 106(n). Generally, content retrieval module 104 retrieves one or more content descriptions 106 and makes those retrieved content descriptions 106 available to screen saver module 102. Screen saver module 102 generates for display a screen saver 108 that includes the retrieved content descriptions 106.

Each content description 106 is associated with or corresponds to particular content. The content refers to any content that can be downloaded to and/or used by device 100 in generating a display (or display signal). Examples of content include video on demand (VOD) programs, previously recorded programs, live programs and/or channels, applications that can be run by device 100 (locally or remotely), and so forth. Some content refers to programs, such as movies, sitcoms, commercials, news broadcasts, documentaries, sporting events, and so forth. Video on demand programs refer to programs that can be purchased for viewing, and typically viewed at the time of purchase. Previously recorded programs refer to programs that have been recorded and are available for viewing (free or available for purchase). For example, a program could have been previously recorded by device 100, by a remote digital video recorder (DVR) coupled to device 100, and so forth.

Live programs and/or channels refer to programs (and/or the channels the programs are being transmitted on) that are currently being transmitted. The live programs and/or channels can refer to live events currently taking place (with or without some time lag), such as sporting events, concerts, and so forth, as well as previously recorded programs. Applications that can be run by device 100 refer to applications that can be downloaded to device 100 and executed, or alternatively that are executed on a remote device or service and have a user interface (UI) that is displayed by device 100. Such applications can be run free of charge, or alternatively can be run after a fee is paid.

Each content description 106 is information describing the associated content. This information can take a variety of different forms, such as a video preview (e.g., a portion of a program), an image, text or other characters or symbols, combinations thereof, and so forth. In one or more embodiments, content description 106 can also include a live feed (e.g., whatever content is currently being transmitted for a live channel).

In one or more embodiments, content descriptions 106 are obtained by content retrieval module 104 from another module or service on device 100. For example, a program guide application on device 100 may maintain information describing content, and module 104 can obtain the information to be used as content descriptions 106 from the program guide data used by the program guide application. Such information could include titles of programs, actors/actresses in programs, summaries of programs, and so forth. In such embodiments, the program guide application can be configured to respond to requests for information describing content from module 104, or to send the information describing content to module 104 without the information being requested by module 104. Alternatively, module 104 can be configured with or otherwise have knowledge of the manner in which the program guide data is stored, and module 104 can access the program guide data to retrieve the information for content descriptions 106.

In other embodiments, content descriptions 106 are obtained by content retrieval module 104 from another module or service remote from device 100. For example, an application or module on one or more remote devices coupled to device 100 via the Internet and/or other networks can maintain information describing content. Content retrieval module 104 can access this other application or module to obtain content descriptions 106. Alternatively, this other application or module can send content descriptions 106 to module 104.

In other embodiments, the content descriptions 106 obtained by content retrieval module 104 are dedicated descriptions used by modules 102 and 104. In such embodiments, content descriptions 106 are authored or otherwise created with an expectation that they will be displayed in a screen saver for a device. Content descriptions 106 are retrieved by module 104 from a remote service or device, and/or are sent from a remote service or device to module 104 without module 104 requesting the descriptions.

Content retrieval module 104 communicates one or more of content descriptions 106 to screen saver module 102. The particular content descriptions communicated to module 102 can be determined in a variety of different manners. In one or more embodiments, all the obtained content descriptions 106 are communicated to module 102. In other embodiments, one or more particular content descriptions 106 from a set of content descriptions 106 currently available to module 104 are selected randomly, based on priority values or weights associated with the content descriptions, based on amounts paid by authors of the content descriptions, based on how recently each of the various content descriptions have been displayed in a screen saver by device 100, based on how soon content corresponding to the content descriptions will be available (e.g., in the situation of an upcoming live program) or will no longer be available (e.g., in the situation of a video on demand program that will not be available on demand much longer), and/or according to other rules or criteria.

Each content description 106 can be identified by a media identifier and optionally a media type. The media identifier identifies the particular content that corresponds to the content description 106. The media type identifies a type of the content (e.g., live channel, VOD program, application, and so forth). The media type identifier can be used to identify a location where the content description 106 for a particular media type can be obtained. For example, content retrieval module 104 can be configured to have knowledge that (or otherwise obtain knowledge that) content descriptions 106 of particular types can be obtained from particular locations. For example, module 104 can have knowledge that content descriptions 106 for live channel and VOD program media types can be obtained from program guide data, whereas content descriptions 106 for applications can be obtained from a remote service.

Thus, by way of example, a set of content identifications can be made available to module 104, such as from a remote device or service. Each of these content identifications includes a media identifier and a media type. Content retrieval module 104 then uses the information in these content identifications to obtain the content descriptions 106. Based on the media types, module 104 knows a location from which the content descriptions 106 can be obtained. Based on the media identifier, module 104 knows which particular content description 106 to obtain.

Screen saver module 102 generates a screen saver to be output as screen saver 108 based on content descriptions 106. In one or more embodiments, device 100 plays back screen saver 108 (e.g., displays video content, plays back audio content, and so forth). In other embodiments device 100 generates one or more signals based on screen saver 108 that is output to one or more other devices (e.g., televisions, screens, projectors, speakers, etc.) which in turn display screen saver 108.

One or more of content descriptions are included in screen saver 108. In one or more embodiments, multiple content descriptions are displayed concurrently in the screen saver, such as in separate windows of the screen saver. Additionally, the content descriptions being displayed in the screen saver can change over time. For example, after a threshold amount of time (such as thirty seconds, five minutes, etc.), the particular content descriptions included in the screen saver 108 can change. The particular content descriptions to be included in screen saver 108 can vary, analogous to the selection of content by module 104 discussed above. All of the content descriptions selected by content retrieval module 104 can be displayed in screen saver 108, or alternatively screen saver module 102 can select particular content descriptions analogous to the selection of content by module 104 discussed above.

Screen saver module 102 generates screen saver 108 in response to a variety of different events. These events can be time-based, or alternatively based on other conditions or actions. In one or more embodiments, module 102 generates screen saver 108 after an amount of time elapses without activity from a user of device 100. For example, if no user inputs are received by device 100 (e.g., from a control panel on device 100, from a remote control device, and so forth) for at least a threshold amount of time, then module 102 generates screen saver 108. In one or more other embodiments, module 102 can also generate screen saver 108 in response to other events. For example, module 102 can generate screen saver 108 each time device 100 is powered-on. By way of another example, module 102 can generate screen saver 108 each time device 100 resumes operation from a hibernation or standby state.

Each time module 102 generates screen saver 108, one or more content descriptions are selected for inclusion in screen saver 108. Different screen savers 108 that are generated can have different content descriptions, or alternatively the same content descriptions for different screen savers 108 can be generated by module 102.

In one or more embodiments, module 102 can also receive user inputs 112, allowing a user of device 100 to interact with screen saver 108. A variety of different interactions can be supported by module 102. In one or more embodiments, a user is able to order content that corresponds to the content descriptions displayed as part of screen saver 108. This ordering can be a direct ordering via screen saver 108, or alternatively an indirect ordering.

A direct ordering refers to a selection of a content description displayed in screen saver 108 resulting in the content corresponding to the selected content description being ordered. Screen saver module 102 can communicate with one or more other modules or components (not shown in FIG. 1) to have the ordered content downloaded, played back, run, and so forth. However, no further input from the user is needed for the ordering of the content. For example, a user can select a particular description of a video on demand program in screen saver 108. In response to the user selection, module 102 accesses an ordering module or component to order the video on demand program for playback on device 100. One or more other modules or components (not shown in FIG. 1) manage the playback of the video on demand program on device 100.

An indirect ordering refers to a selection of a content description in screen saver 108 causing a content acquisition interface to be displayed. This content acquisition interface can allow the user to, for example, order a video on demand program, purchase an application, and so forth. One or more other components or modules present the content acquisition interface, and can allow the content to be ordered for playback, downloading, running, and so forth to device 100.

Screen saver 108 displays at least some of each content description that is included in the screen saver, and can display this information in a variety of different formats or layouts. In one or more embodiments, screen saver 108 is displayed having multiple windows or portions. These windows can be, for example, picture-in-picture (PIP) windows or alternatively other portions being displayed. At least part of a content description can be displayed in each of these windows, while other information from the content description is displayed in other areas of the screen saver. For example, a particular video clip or image can be displayed within a window of screen saver 108, and additional text describing the content can be displayed in another portion of screen saver 108. This other portion could be adjacent to the window in which the video clip is displayed, or alternatively elsewhere in screen saver 108. The additional text describing the content could also alternatively be displayed overlaying at least a portion of the window in which the video clip is displayed.

The additional text describing content can be displayed for multiple content descriptions concurrently in screen saver 108, or alternatively a particular content description can be selected and the additional text for just the selected content description displayed at any given time. In this situation, the particular content description can be selected in a variety of different manners. For example, the user of device 100 could select a particular content description using a remote control device that communicates with device 100, or using a control panel of device 100. By way of another example, the particular content description can be selected by screen saver module 102 (or alternatively another component or module) randomly, based on payments received, based on preferences of a user of device 100, in accordance with other rules or criteria, and so forth.

Which particular window or portion is selected can be identified via the screen saver 108 in different manners. For example, a border around the window or portion can be changed (e.g., a thickness of the border, a color of the border, a brightness of the border, etc.). By way of another example, the non-selected windows or portions could be grayed out or shaded. By way of yet another example, the selected window or portion could be moved to a particular location and/or the size of the selected window or portion could be changed (e.g., the selected window could be the biggest window on the display).

The windows or portions of screen saver 108 in which content descriptions are displayed can be stationary or alternatively moving. The speed at which windows or portions can move can vary, being the same or alternatively different for different windows or portions. In one or more embodiments, the movement of windows or portions coincides with a change in the content descriptions being displayed in the windows or portions. For example, each time the content descriptions displayed in the windows or portions is changed, the locations of the windows or portions is changed. In other embodiments, the movement of windows or portions is regardless of the content descriptions being displayed therein. For example, the different windows or portions can be displayed so as to appear to move or float around the screen.

In addition to the windows or portions moving, different characteristics of the windows can also change. These different characteristics include, for example, the orientation of the windows or portions, the size of the windows or portions, and so forth.

Screen saver module 102 can determine the location and/or movement of each portion or window in a variety of different manners. In one or more embodiments, module 102 is configured with one or more templates describing the locations and/or movement for each portion or window, and generates screen saver 108 in accordance with one of these templates. Which template to use can be selected in a variety of manners, such as randomly, based on a user preference or request for a particular template, in accordance with some other rules or criteria, and so forth.

Alternatively, module 102 can determine the location and/or movement of each portion or window in different manners. For example, the location and/or movement can be selected by module 102 randomly, can be selected based on a user preference or request for a particular location and/or movement, can be selected based on some other rules or criteria provided by an administrator of device 100 (or an author of content descriptions 106), and so forth.

Different selections are discussed above, including selection of particular content to be ordered and selection of a particular content description being displayed in screen saver 108. These selections can be performed by a user of device 100 in a variety of different manners. For example, a remote control device can communicate with device 100 to allow the user to make a selection, such as by entering a control key or sequence, moving a pointer to highlight a particular content description, pointing the remote control device at a particular content description, activating a touch screen or other input mechanism to scroll through content descriptions, and so forth. By way of another example, a control pad or other input can be included as part of device 100 to allow the user to make a selection, such as by entering a control key or sequence, moving a pointer to highlight a particular content description, activating a touch screen or other input mechanism to scroll through content descriptions, and so forth. Alternatively, selections can be made in other manners, such as voice inputs, hand motions being detected by device 100, eye movement being detected by device 100, and so forth.

The user of device 100 is thus able to interact with screen saver 108, selecting a particular content description for which additional parts of the content description are displayed, selecting particular content for ordering, and so forth. Screen saver 108 can thus continue to be displayed while some user inputs are received, whereas module 102 ceases display of screen saver 108 in response to other user inputs. When module 102 ceases display of screen saver 108, the display to be output by device 100 is generated by another module or component. This display could be display of ordered content (e.g., video on demand program, application, etc.), display of another channel or program (e.g., whatever was being displayed before screen saver 108 began being displayed), and so forth.

Which user inputs result in interaction with screen saver 108 and which user inputs cause the display of screen saver 108 to cease can vary. For example, particular keys, remote control device movements, voice inputs, and so forth can be reserved for use as interaction with screen saver 108. Thus, when such keys, movements, voice inputs, and so forth are input to device 100, module 102 interprets such input as interaction with screen saver 108 rather than an input to cease display of screen saver 108.

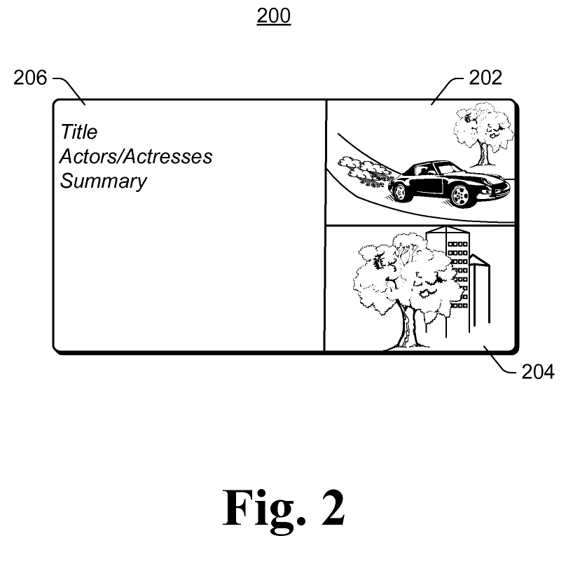

FIGS. 2, 3, and 4 illustrate example screen savers in accordance with one or more embodiments. These screen savers illustrated in FIGS. 2, 3, and 4 are examples of screen saver 108 of FIG. 1. It is to be appreciated that these illustrated screen savers are only examples, and that a variety of other screen savers and formats can be used as discussed above.

FIG. 2 illustrates an example screen saver 200 including portions 202, 204, and 206. Part of a content description in the form of a video clip is displayed in portion 202. Part of a different content description in the form of a video clip is displayed in portion 204. A user can select one of portions 202 and 204 as discussed above, and an additional part of the content description in the selected portion is displayed in portion 206. In the illustrated example, portion 206 displays a title, one or more actors and/or actresses, and a summary from the selected content description.

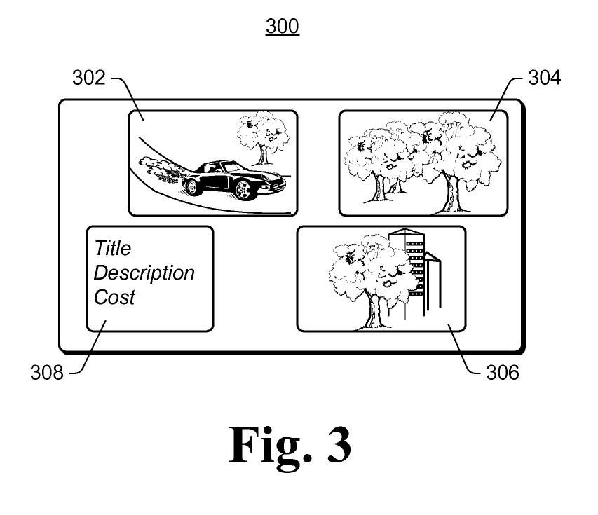

FIG. 3 illustrates an example screen saver 300 including portions 302, 304, 306, and 308. Part of a content description in the form of a video clip is displayed in portion 302. Part of a different content description in the form of a still image is displayed in portion 304. Part of yet another content description in the form of a video clip is displayed in portion 306. A user can select one of portions 302, 304, and 306 as discussed above, and an additional part of the content description in the selected portion is displayed in portion 308. In the illustrated example, portion 308 displays a title, description, and cost of an application that can be run.

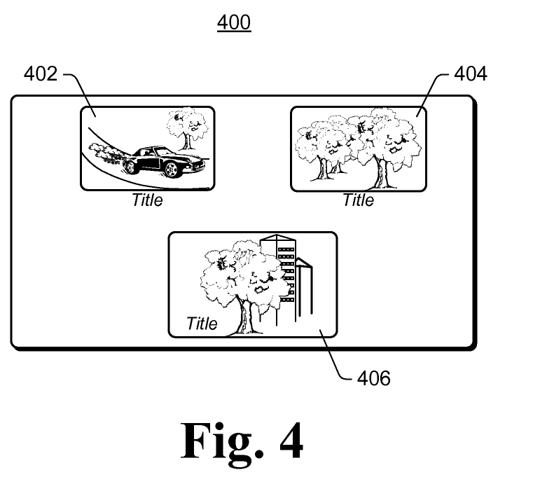

FIG. 4 illustrates an example screen saver 400 including portions 402, 404, and 406. Part of a content description in the form of a video clip is displayed in portion 402. Another part of that same content description in the form of a text description (e.g., a title) is displayed adjacent to portion 402.

Part of a different content description in the form of a video clip is displayed in portion 404. Another part of that same content description in the form of a text description (e.g., a title) is displayed adjacent to portion 404.

Part of yet another content description in the form of a video clip is displayed in portion 406. Another part of that same content description in the form of a text description (e.g., a title) is displayed overlaying portion 406.

In one or more embodiments, a user can directly order content corresponding to one of the content descriptions from screen saver 200, 300, or 400 as discussed above. For example, the user could select one of the portions (e.g., 202-206, 302-308, or 402-406) then enter an “order” command in a variety of different manners, such as pressing an “order” button on a remote control device or control panel of device 100, inputting a verbal “order” command, and so forth.

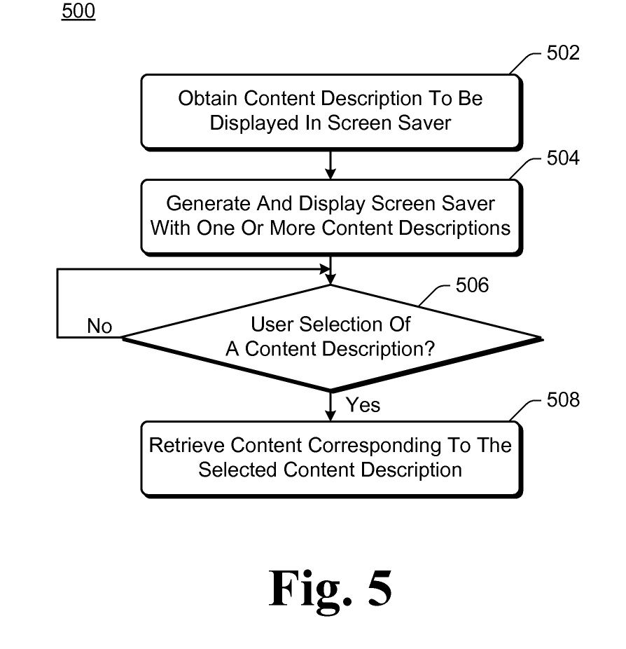

FIG. 5 is a flowchart illustrating an example process 500 for displaying available content via a screen saver in accordance with one or more embodiments. Process 500 is carried out by a device, such as device 100 of FIG. 1, and can be implemented in software, firmware, hardware, or combinations thereof. Process 500 is an example process for displaying available content via a screen saver; additional discussions of displaying available content via a screen saver are included herein with reference to different figures.

In process 500, a content description to be displayed in a screen saver is obtained (act 502). As discussed above, this content description can be obtained in a variety of different manners. Each content description to be included in a screen saver is obtained in act 502.

A screen saver with one or more content descriptions is generated and displayed (act 504). The one or more content descriptions in the screen saver are those that were obtained in act 502. As discussed above, the screen saver can be displayed in a variety of different formats or layouts.

Process 500 then proceeds based on whether a content description is selected by a user (act 506). In response to a content description being selected by the user, the content corresponding to the selected content description is retrieved (act 508). As discussed above, this retrieval can include various actions, such as downloading and displaying the content, downloading and storing the content, displaying a user interface for an application, and so forth. The content can be downloaded and/or played back in any of a variety of conventional manners.

Process 500 is performed each time a screen saver is to be generated. As discussed above, a screen saver can be generated at different times, such as when the device implementing process 500 is powered-on, after an amount of time with no user activity elapses, and so forth.

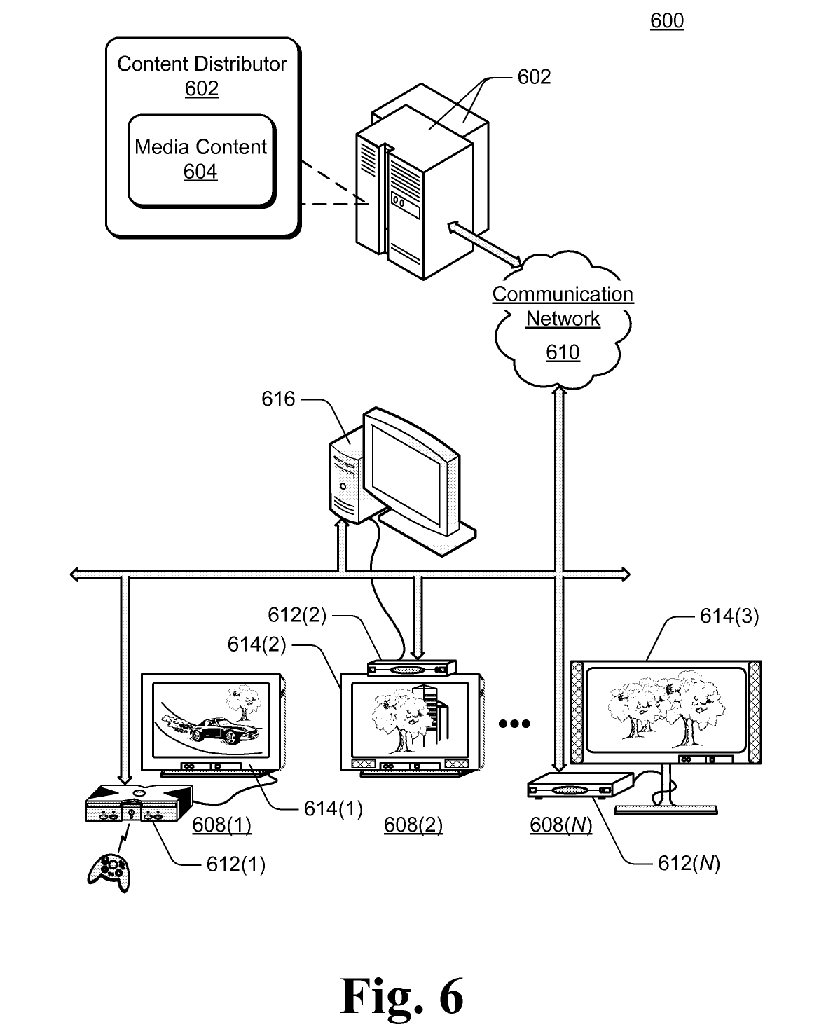

FIG. 6 illustrates an example system 600 in which one or more embodiments of displaying available content via a screen saver can be implemented. System 600 includes one or more content distributors 602 that communicate media content 604 to any number “N” of various television client systems 608(1-N) via a communication network 610. Client systems 608 can each be, for example, a different type (or alternatively the same types) of device 100 of FIG. 1. Communication network 610 can be implemented to include an IP-based network that facilitates media content distribution and data communication between the content distributor(s) 602 and any number of television client devices.

Each of client systems 608(1-N) includes a respective television client device 612(1-N) and a respective display device 614(1-N), such as any type of television, monitor, LCD, projector, or similar television-based display system that renders audio, video, and/or image data. Any of client devices 612(1-N) can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device. Any of television client devices 612(1-N) may also be associated with a user (e.g., a person) and/or an entity that operates a client device such that a television client device describes logical clients that include users, software, and/or devices. In this example of FIG. 6, client device 612(2) is a television set-top box that is connected, or otherwise communicatively linked, to a computing device 616.

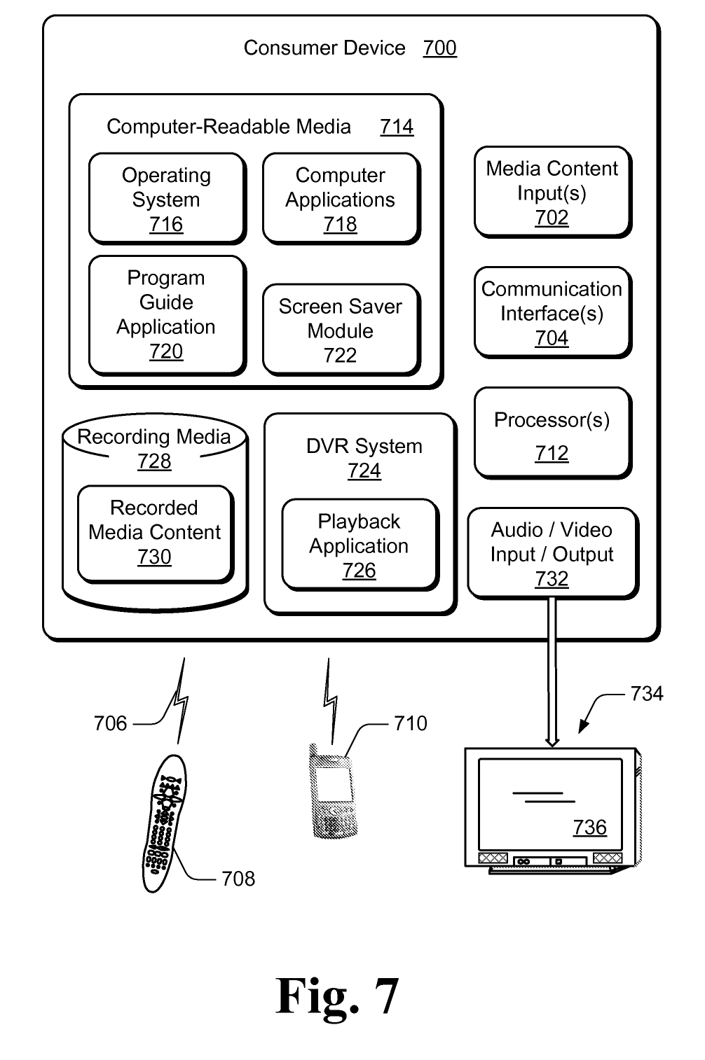

Any of television client devices 612(1-N) of the respective client systems 608(1-N) can be implemented with one or more processors, a communication module, memory components, a media content rendering system, a content retrieval module, and a screen saver module to implement embodiments of displaying available content via a screen saver. Additionally, each of television client devices 612(1-N) can be configured for communication with any number of different content distributors 602 to receive any type of media content 604 via the communication network 610. Further, any of the television client devices 612(1-N) can be implemented with any number and combination of differing components as further described with reference to the example client device shown in FIG. 7.

FIG. 7 illustrates various components of an example consumer device 700 that can be implemented as any form of a computing, electronic, or television client device to implement one or more embodiments of displaying available content via a screen saver. For example, consumer device 700 can be implemented as a device 100 shown in FIG. 1, and/or as any of the client devices 612(1-N) of client systems 608(1-N) shown in FIG. 6. In various embodiments, consumer device 700 can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device.

Consumer device 700 includes one or more media content inputs 702 that may include Internet Protocol (IP) inputs over which streams of media content are received via an IP-based network. Consumer device 700 further includes communication interface(s) 704 that can be implemented as any one or more of a serial and/or parallel interface, a wireless interface, any type of network interface, a modem, and as any other type of communication interface. A wireless interface enables client device 700 to receive control input commands 706 and other information from an input device, such as from remote control device 708, a portable computing-based device (such as a cellular phone) 710, or from another infrared (IR), 802.11, Bluetooth, or similar RF input device.

A network interface provides a connection between consumer device 700 and a communication network by which other electronic and computing devices can communicate data with device 700. Similarly, a serial and/or parallel interface provides for data communication directly between client device 700 and the other electronic or computing devices. A modem facilitates client device 700 communication with other electronic and computing devices via a conventional telephone line, a DSL connection, cable, and/or other type of connection.

Consumer device 700 also includes one or more processors 712 (e.g., any of microprocessors, controllers, and the like) which process various computer-executable instructions to control the operation of device 700, to communicate with other electronic and computing devices, and to implement embodiments of displaying available content via a screen saver. Consumer device 700 can be implemented with computer-readable media 714, such as one or more memory components, examples of which include random access memory (RAM), nonvolatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer-readable media 714 provides data storage mechanisms to store various information and/or data such as software applications and any other types of information and data related to operational aspects of consumer device 700. For example, an operating system 716 and/or other computer applications 718 can be maintained as software applications with the computer-readable media 714 and executed on processor(s) 712 to implement embodiments of the displaying available content via a screen saver. Computer applications 718 can, for example, be downloaded as content as discussed above.

Consumer device 700 can also include a program guide application 720 that is implemented to process program guide data and generate program guides for display. A program guide enables a viewer to navigate through an onscreen display and locate various media content such as broadcast programs, recorded programs, video on demand programs and movies, interactive game selections, network-based applications, and other media content of interest to the viewer. Consumer device 700 can also include a screen saver module 722 (shown as a software module in this example) to implement various embodiments of displaying available content via a screen saver as described herein. Other modules, such as a content retrieval module, can also be included in consumer device 700, or alternatively incorporated into other components or modules of consumer device 700. For example, a content retrieval module can be incorporated into screen saver module 722.

Consumer device 700 can also include a DVR system 724 with playback application 726, and recording media 728 to maintain recorded media content 730 that consumer device 700 receives and/or records. Further, consumer device 700 may access or receive additional recorded media content that is maintained with a remote data store (not shown). Consumer device 700 may also receive media content from a video on demand server, or media content that is maintained at a broadcast center or content distributor that distributes the media content to subscriber sites and client devices. Playback application 726 is a video control application that can be implemented to control the playback of media content, the recorded media content 730, and/or other video on demand media content, music, and any other audio, video, and/or image media content which can be rendered and/or displayed for viewing.

Consumer device 700 also includes an audio and/or video output 732 that provides audio and/or video data to an audio rendering and/or display system 734. Audio rendering and/or display system 734 can include any devices that process, display, and/or otherwise render audio, video, and image data. Video signals and audio signals can be communicated from consumer device 700 to a display device 736 via an RF (radio frequency) link, S-video link, composite video link, component video link, DVI (digital video interface), analog audio connection, or other similar communication link. Alternatively, audio rendering and/or display system 734 can be implemented as integrated components of the example consumer device 700. Consumer device 700 along with the audio rendering and/or display system 734 is an example of a viewing system that can be implemented in a household viewing area for viewing television programs and/or receiving other television media content.

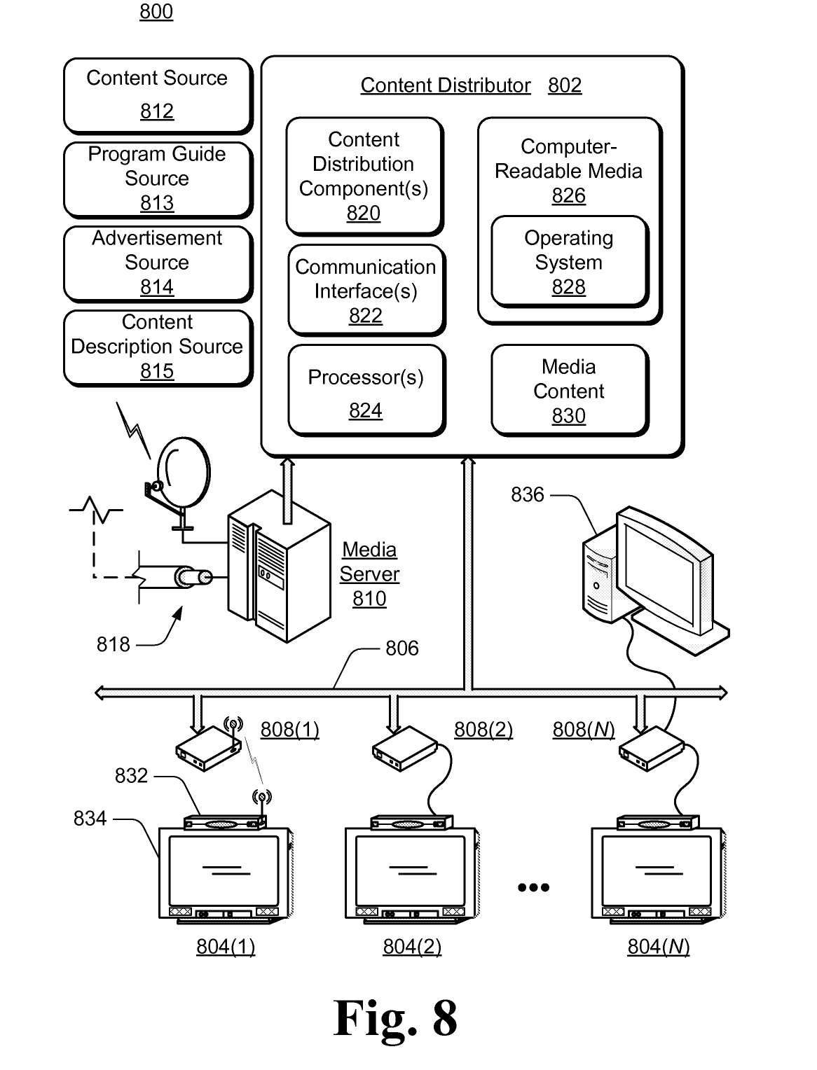

FIG. 8 illustrates an example entertainment and information system 800 in which one or more embodiments of displaying available content via a screen saver can be implemented. System 800 facilitates the distribution of media content, program guide data, advertising content, and content descriptions to multiple viewers and to multiple viewing systems. System 800 includes a content distributor 802 and any number “N” of client systems 804(1-N) each configured for communication via a communication network 806. Each client system 804(1-N) is an example of the client systems 608(1-N) described with reference to FIG. 6. Each of the client systems 804(1-N) can receive data streams of media content, media content, program guide data, advertising content, closed captioning data, other content, and the like from content server(s) of content distributor 802 via communication network 806.

Communication network 806 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 806 can be implemented using any type of network topology and any network communication protocol, and can be represented or otherwise implemented as a combination of two or more networks. A digital network can include various hardwired and/or wireless links 808(1-N), routers, gateways, and so on to facilitate communication between content distributor 802 and client systems 804(1-N).

System 800 includes a media server 810 that receives media content from a content source 812, program guide data from a program guide source 813, advertising content from an advertisement source 814, and optionally content descriptions from a content description source 815. Alternatively, content descriptions can be obtained from other sources, such as program guide data source 813, as discussed above. In one or more embodiments, media server 810 represents an acquisition server that receives the audio and video media content from content source 812, an EPG server that receives the program guide data from program guide source 813, an advertising management server that receives the advertising content from the advertisement source 814, and/or a content server that receives the content descriptions from content description source 815.

Content source 812, program guide source 813, advertisement source 814, and content description source 815 control distribution of the media content, the program guide data, at least some of the advertising content, and the content descriptions to the media server 810 and/or to other servers. The media content, program guide data, advertising content, and content descriptions can be distributed via various transmission media 818, such as satellite transmission, radio frequency transmission, cable transmission, and/or via any number of other wired or wireless transmission media. In this example, media server 810 is shown as an independent component of system 800 that communicates the media content, program guide data, advertising content, and content descriptions to content distributor 802. In an alternate implementation, media server 810 can be implemented as a component of content distributor 802.

Content distributor 802 is representative of a headend service in a content distribution system, for example, that provides the media content, program guide data, advertising content, and content descriptions to multiple subscribers (e.g., the client systems 804(1-N)). Content distributor 802 can be implemented as a satellite operator, a network television operator, a cable operator, and the like to control distribution of media content, program and advertising content, and content descriptions, such as movies, television programs, commercials, music, and other audio, video, and/or image content to client systems 804(1-N).

Content distributor 802 includes various content distribution components 820 to facilitate media content processing and distribution, such as a subscriber manager, a device monitor, and one or more content servers. The subscriber manager manages subscriber data, and the device monitor monitors client systems 804(1-N) (e.g., and the subscribers), and maintains monitored client state information.

Although the various managers, servers, and monitors of content distributor 802 (to include media server 810 in one or more embodiments) are described as distributed, independent components of content distributor 802, any one or more of the managers, servers, and monitors can be implemented together as a multi-functional component of content distributor 802. Additionally, any one or more of the managers, servers, and monitors described with reference to system 800 can implement features and embodiments of displaying available content via a screen saver.

Content distributor 802 includes communication interface(s) 822 that can be implemented as any type of interface to communicate and receive data from client devices of the television system. Content distributor 802 also includes one or more processors 824 (e.g., any of microprocessors, controllers, and the like) which process various computer-executable instructions to control the operation of content distributor 802. Content distributor 802 can be implemented with computer-readable media 826 which provides data storage to maintain software applications such as an operating system 828 and media content 830 for distribution to the client systems 804(1-N).

Client systems 804(1-N) can each be implemented to include a client device 832 and a display device 834 (e.g., a television, LCD, and the like). A client device 832 of a respective client system 804 can be implemented in any number of embodiments, such as a set-top box, a digital video recorder (DVR) and playback system, an appliance device, a gaming system, and as any other type of client device that may be implemented in an entertainment and information system. In an alternate embodiment, client system 804(N) is implemented with a computing device 836 as well as a client device. The computing device 836 is an example of a connected data store that can record and maintain media content for a client device. Additionally, any client device 832 of a respective client system 804 can implement features and embodiments of displaying available content via a screen saver as described herein.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer-readable memory devices. The features of the displaying available content via a screen saver techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer-readable media having stored thereon multiple instructions that, when executed by one or more processors of a device, cause the one or more processors to:
obtain multiple content descriptions, each content description identifying content that is available to the device; and
generate a screen saver to concurrently display each of the multiple content descriptions as at least part of a screen saver for the device.

2. One or more computer-readable media as recited in claim 1, wherein each of the multiple content descriptions comprises a portion of a different video on demand program.

3. One or more computer-readable media as recited in claim 1, wherein one or more of the multiple content descriptions comprises a description of a live television program.

4. One or more computer-readable media as recited in claim 1, wherein one or more of the multiple content descriptions comprises a description of a previously recorded program.

5. One or more computer-readable media as recited in claim 1, wherein one or more of the multiple content descriptions comprises an application that can be run by the device.

6. One or more computer-readable media as recited in claim 1, wherein the instructions further cause the one or more processors to:
receive a user selection of one of the multiple content descriptions displayed as part of the screen saver; and
display, in response to the user selection, additional information describing the one of the multiple content descriptions.

7. One or more computer-readable media as recited in claim 6, wherein the instructions further cause the one or more processors to:
receive a user request to order a video on demand program; and
retrieve and display, in response to the user request, the video on demand program.

8. One or more computer-readable media as recited in claim 1, wherein the instructions further cause the one or more processors to:
receive a user selection of one of the multiple content descriptions displayed as part of the screen saver; and
retrieve content associated with the one of the multiple content descriptions for display by the device.

9. One or more computer-readable media as recited in claim 1, wherein to obtain the multiple content descriptions is to obtain one or more of the multiple content descriptions from program guide data.

10. One or more computer-readable media as recited in claim 1, the screen saver comprising multiple portions, a first portion of the multiple portions displaying a part of a first content description of the multiple content descriptions, a second portion of the multiple portions displaying a part of a second content description of the multiple content descriptions, and a third portion displaying another part of the first content description when the first portion is selected and displaying another part of the second content description when the second portion is selected.

11. A method implemented in a device, the method comprising:
obtaining content descriptions that identify content that is available to the device; and
generating a screen saver for the device, the screen saver including the content descriptions.

12. A method as recited in claim 11, wherein each of the content descriptions comprises a portion of a different video on demand program.

13. A method as recited in claim 11, further comprising:
receiving a user selection of one of the multiple content descriptions displayed as part of the screen saver; and
retrieving content associated with the one of the multiple content descriptions for display by the device.

14. A method as recited in claim 11, obtaining the multiple content descriptions comprises obtaining one or more of the multiple content descriptions from a program guide application.

15. A method as recited in claim 11, each of the content descriptions being identified by both a media identifier of content corresponding to the content description and a media type of the content.

16. A method as recited in claim 11, the screen saver comprising multiple portions, a first portion of the multiple portions displaying a part of a first content description, a second portion of the multiple portions displaying a part of a second content description, and a third portion displaying another part of the first content description when the first portion is selected and displaying another part of the second content description when the second portion is selected.

17. A method as recited in claim 11, the screen saver comprising multiple portions, a first portion of the multiple portions displaying a part of a first content description, another part of the first content description being displayed adjacent to the first portion, and a second portion of the multiple portions displaying a part of a second content description, and another part of the second content description being displayed adjacent to the second portion.

18. A device comprising:
a content retrieval module to obtain multiple content descriptions, each content description identifying content that is available to the device; and
a screen saver module to generate a screen saver for the device, the screen saver including the multiple content descriptions.

19. A device as recited in claim 18, wherein the screen saver module is further to:
receive a user selection of one of the multiple content descriptions displayed as part of the screen saver; and
retrieve content corresponding to the one of the multiple content descriptions for display by the device.

20. A device as recited in claim 18, wherein to obtain the multiple content descriptions is to obtain one or more of the multiple content descriptions from program guide data.
